(19) United States
(12) Patent Application Publication
(10) Pub. No.: US 2021/0368740 A1
(43) Pub. Date: Dec. 2, 2021

(54) Dog and Cat Collar Supporting Electromagnetic Remediation

(71) Applicant: John Robbins, Costa Mesa, CA (US)

(72) Inventor: John Robbins, Costa Mesa, CA (US)

(21) Appl. No.: 17/329,626

(22) Filed: May 25, 2021

Related U.S. Application Data
(60) Provisional application No. 63/101,977, filed on May 26, 2020.

(51) Int. Cl. A01K 27/00

(52) U.S. Cl. CPC A01K 27/001; A01K 27/009

(57) ABSTRACT

The present invention is directed to the prevention of EMF wave damage to the cells of dogs and cats. The invention features a Tachyon infused collar that may comprise a base strip with webbing material. The collar with a remediation energy converts chaotic EMF waves into non-damaging waves. Alternatively, the webbing material may be infused with a combination of Tachyon and shungite as further enhancement of the invention. In another embodiment, filler material for a bed or pillow for a dog or cat is infused with Tachyon or a combination of Tachyon and shungite.

### CROSS REFERENCE TO RELATED APPLICATIONS

Applicant claims priority to provisional application filed on May 26, 2020, No. 63/101,977.

### STATEMENT REGARDING FEDERAL SPONSORED RESEARCH

None.

### PARTIES TO JOINT RESEARCH AGREEMENT

None.

### FIELD OF THE INVENTION

Electromagnetic field “EMF” refers to a field created when energy is reflected, absorbed or emitted from objects by electrical or magnetic waves. EMF emissions include “dirty electricity,” gamma rays, X-rays, ultraviolet radiation, visible light, microwaves, radio waves, and infrared radiation. EMF is emitted from products in many industries, such as communications, military weaponry, and commercial products. The use of EMF is increasing throughout the world and being commercially promoted due to its benefits and versatility for Wi-Fi, smart meters, and cell phones. The broad usage has a lot to do with the ability of microwave EMF energy to penetrate concrete structures that normally block the passage of other forms of energy.

There is a serious downside to the presence of EMF. Dirty electricity describes an electrical phenomenon which occurs when alternating current is used. Examples are: moving magnets in devices such as electric motors, converting higher energy to lower energy by transformers, converting lower energy into higher energy by inverters, and converting lower energy D.C. into higher energy A.C., as in solar panels. The ubiquitous presence of dirty electricity can be harmful to human health, see the “Summary” written and compiled by Martin L. Pall, PhD., Professor Emeritus in Biochemistry and Basic Medical Science at Washington State University, “5G: Great Risk for EU, U.S., and International Health! Compelling Evidence for Eight Distinct Types of Great Harm Caused by Electromagnetic Field (EMF) Exposures and the Mechanism that Causes Them,” (May 2018).

Over 10,000 studies by independent researchers have shown that EMF damages humans and animals. Dr. Barrie Trower, a well-known EMF expert and research scientist for the police union, conducted a comprehensive study on the side effects of use of the TETRA communication device which is widely used by first responders, and he showed an increasing trend in heart attacks, cancer, and many other diseases (“Confidential Report on TETRA Strictly for the Police Federation of England and Wales,” September 2001.) He is also quoted as saying, “The problem with the microwave communications industry is that they do not have to prove it is safe; you have to prove it is not, and that is an entirely different ball game. As a scientist, if I develop a new pill, I have to run a five- or ten-year clinical trial and convince a board of my peers that it is safe before I have permission to release the pill onto the market. With the telecommunications industry, the tables are completely turned around. They do not have to show these instruments are safe; you have to show they are not.” See (http://whale.to/a/trower_q.html). Electrical pollution is not something that can be seen, smelled, tasted, or felt. Since it cannot be sensed by most humans, it is difficult to determine the presence of EMF. Much of the world is blanketed by EMF, without many being aware of its presence. Microwaves are an insidious form of EMF damage. Concerning the safety aspects, regulatory agencies are only focusing on the heat being emitted by the microwave devices, when they should be looking at the DNA damage to chromosomes for long-term as well as short-term harmful health effects.

Lack of diagnostic equipment that can clearly demonstrate biological harm has made it difficult to directly identify the harm EMF causes. Many of the symptoms caused by EMF can also be attributed to other illnesses and diseases. The accepted method for determining the adverse impact on health due to EMF exposure is to measure the heat emitting from the device being tested. This type of testing does not show the more serious damage being done to the DNA, specifically to the mitochondria DNA that is passed on from generation to generation.

Current studies tend to focus on heat measurement and ignore the more serious biological damage to the DNA. Safety experts conducting these studies advise holding a communication device away from the body while using the device. Additionally, their advice is to turn off the device or put a Faraday cage around the device to block or limit the EMF emissions. Some people paint their houses, coat their walls with anti-electromagnetic paints and hang anti-electromagnetic curtains over their windows to block the harmful effects of EMF in an attempt to eliminate the problem. But, an issue arises where if even a small amount of EMF happens to intrude into a dog or cat's living space, reflected energy from the EMF will bounce off the surfaces and intensify the problem. If the protection against EMF is successful, the device will not work because the signal will have been blocked. A primary focus of my invention is to not block or absorb the EMF but to convert the harmful EMF waves being emitted to “friendly” beneficial waves, which allows full use of devices without any of the deleterious health effects. Every cell in living organisms has an electromagnetic field surrounding it. This field is very well organized, using voltage gate channels, contained in an outer membrane of the cell, which allows minerals to move in and toxins to move out of the cell. When in an EMF environment, such as with cell phones, smart meters, Wi-Fi, etc., this field becomes chaotic which will cause the voltage gate calcium channel to open up, flooding the cell with calcium, thus, preventing the ability of the cell to produce nitric oxide which is a necessary element for energy to the mitochondria. The proposed invention application involves reorganization of the chaos at a subatomic level, thus, converting the harmful EMF into a friendly healthful environment. Once a material is placed into the sealed vault, highly focused energy, known as “Tachyon,” is concentrated into the material, saturating it with Tachyon at the subatomic level; thereby, permanently altering its field which will then constantly emit healthful converted waves. Commercial uses for Tachyon are well known, see https://tachyonize.com, and Wagner U.S. Pat. No. 7,760,357 page 1, col. 1. My application does not claim to invent Tachyon, nor tout all of its uses. This application teaches a device for protection of dogs and cats from EMF.

Studies are beginning to show how EMF damage is caused. Cancer is on the increase, and EMF has been identified as a significant contributing factor and cause. Many other diseases and conditions can be traced back to EMF intrusion. One specific and known danger caused by EMF is the coagulation of red blood cells when living things are subjected to devices such as Wi-Fi, smart meters, and cell phones. Tests have shown that following prolonged use of these devices, there are deviations from normal structures in red blood cells.

Research has shown damage to animals cells, when placed in an EMF environment. The damage to the cells comprises inhibiting the ability to process nitric oxide, which is a vital source of energy production for the cells.

EMF causes red blood cells to coagulate and bunch together, making it difficult for oxygen to flow to areas that are fed by capillaries. The diameter of a human capillary is about 6.2 to 8.2 microns, and the diameter of red blood cells carrying oxygen to tissues is over 6 microns, making only one red blood cell at a time able to move through the capillaries. When a blockage occurs, growth and repair of tissues becomes impaired.

Capillaries make up about 75% of the blood vessels in the body. There are many areas in the body only fed by capillaries. They are called “watershed” areas, such as valves in the heart and areas in the brain which control the respiratory and other functions. Many diseases and illness syndromes are caused by the lack of oxygen being delivered to these watershed areas.

From a marketing perspective, reflecting, absorbing, or turning off a device, reduces the usefulness of the device and has met with resistance by consumers. Because the desire to continue using microwave technology is so strong, the ideal remediation is to correct the damaging waves before they can harm the body.

### BRIEF SUMMARY OF THE INVENTION

It is an objective of the present invention to provide solutions that allow the reduction or elimination of cell damage due to EMF, thereby, allowing devices emitting EMF to be used without harming the cells of animals or humans while in an EMF environment.

To meet the objective of protecting cells in proximity to EMF, the present invention proposes to saturate objects worn and/or used by dogs and cats, such as collars, leashes and beds/pillows, with Tachyon. A vault containing Tachyon neutralizes and harmonizes the negative effects of harmful EMF.

The present invention features objects capable of limiting damaging EMF waves to allow for improved physical well-being of a dog or cat using said objects. The collar may comprise a base webbing material containing Tachyon, or energy infusion, designed to remain in or a part of the webbing material. The webbing material has a first end and a second end, a first fastener with a male prong disposed on the first end, and a second fastener with a female slot disposed on the second end, to permit insertion of the first fastener into the second fastener. A base strip may comprise a webbing material. The collar may further comprise a leash ring. A remediation feature such as a vault containing Tachyon, or energy infusion, is impregnated into the webbing material throughout. The remediation feature may also be infused onto a collar webbing material. The saturated collar webbing remains fully functional even if it is scratched by a dog or cat.

In an alternative embodiment, the remediation feature may involve filler material in a bed/pillow for the cat or dog, being infused with Tachyon.

An advantage of impregnating the remediation feature into the entire collar webbing or into the filler material for a dog or cat's bed/pillow, is that the effectiveness of the Tachyon will be extended all around the animal's neck or body, creating a more homogeneous field of remediation energy. Another unique advantage is that the collar or filler material for the bed can be washed without worry of damaging the effectiveness of the EMF remediation feature impregnated into the collar.

Every cell of a dog, cat, or human contains a very subtle, low level organized EMF around the cell. Each cell structure contains a very unique, harmonic frequency for that cell. When the cell EMF structure is altered due to increased exposure to external EMF or chaos in the field, the health of the cell can be compromised. The impregnated energy put into the webbing material preserves the harmonic frequency of healthy cells, allowing them to function when surrounded by a subtle electromagnetic field.

Without wishing to limit the invention to any theory or mechanism, it is believed that the technical feature of the present invention advantageously provides for efficient prevention of EMF wave damage to the cells of the wearer or user. None of the presently known prior references or work has the unique inventive technical feature of the present invention, which is intended to promote lasting protection and does not wear out over time. Any feature or combination of features described herein are included within the scope of the present invention, provided that the features included in any such combination are not mutually inconsistent, as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1 Shows Tachyon energy impregnated or infused into a collar's webbing material which is emitted as a field around the collar for its entire length and circumference. EMF directed toward the animal from external sources intercepted and converted to harmless energy by the collar.

FIG. 2 Shows an embodiment of a dog collar in with buckles used as the fastening mechanism.

FIG. 3 shows an alternate method, utilizing shungite powder mixed with hot glue and applied to the interior side of the webbing. The hot glue will bind to the Tachyon saturated collar.

FIG. 4 is an exploded view of a dog bed or pillow infused with Tachyon.

### DETAILED DESCRIPTION OF THE INVENTION

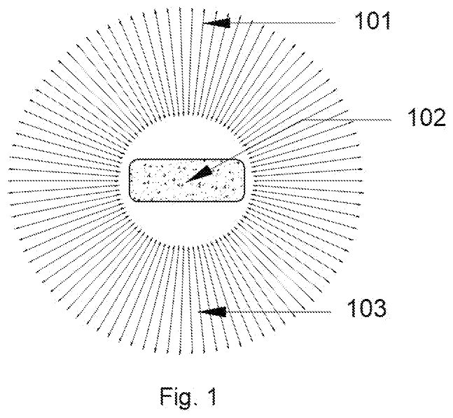

FIG. 1 shows an EMF remediation collar (102) for converting chaotic EMF waves into non-damaging waves. Tachyon is impregnated or infused into the collar webbing which then emits a field around the collar for its entire length and circumference (103). EMF directed toward the animal from external sources (101) is intercepted and converted to harmless energy by the collar.

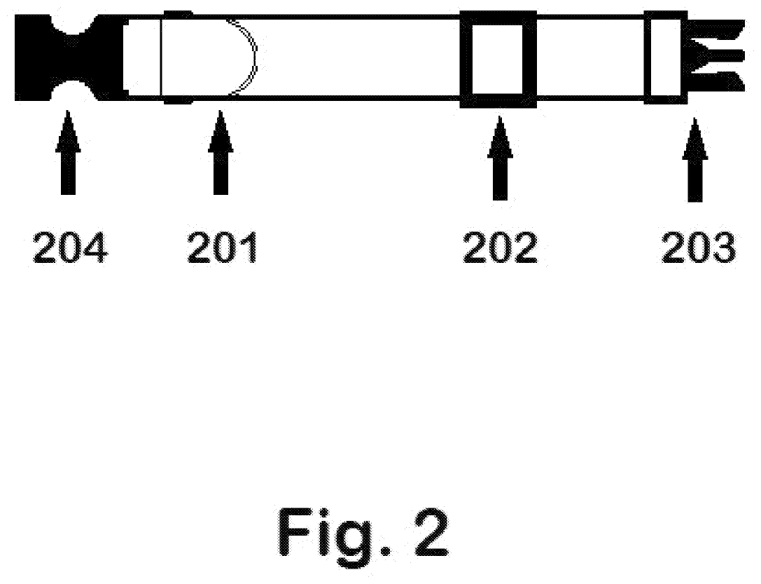

FIG. 2 shows an embodiment of the collar (201). The collar may comprise a base strip (202) having a first male end (203) and a second female end (204). The base strip may comprise a nylon webbing material infused with Tachyon. The collar (201) may further comprise a first fastener disposed on the first end of the base strip and a second fastener disposed on the second end of the base strip. The first fastener and the second fastener may comprise a hook and loop fastener, a buckle, or any similar connecting device that allows mating surfaces to attach to each other. The remediation material may be capable of converting chaotic EMF waves into non-damaging waves. The collar (201) may further comprise a leash ring.

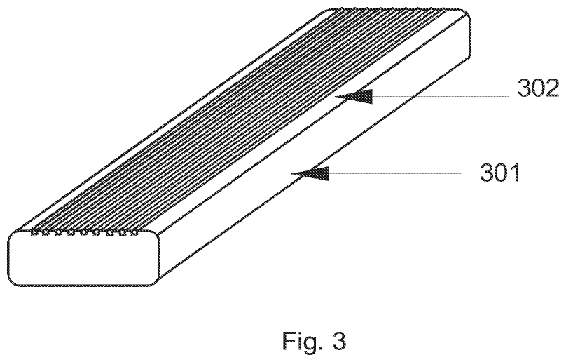

FIG. 3 shows an EMF remediation animal collar (301) for the conversion of chaotic EMF waves into non-damaging waves. The hot glue (302) will bind to the Tachyon saturated collar. A combination of Tachyon energy and shungite powder enhances the overall ameliorative effects. There are many types of healing crystals, but some are exceptionally unique. One example is shungite, a rare stone that appears to work against pollutants, free radicals, and harmful germs without harming an animal's body. There are also claims that shungite may help shield a human or animal body from EMF exposure. See https://healthline.com/health/shungite.

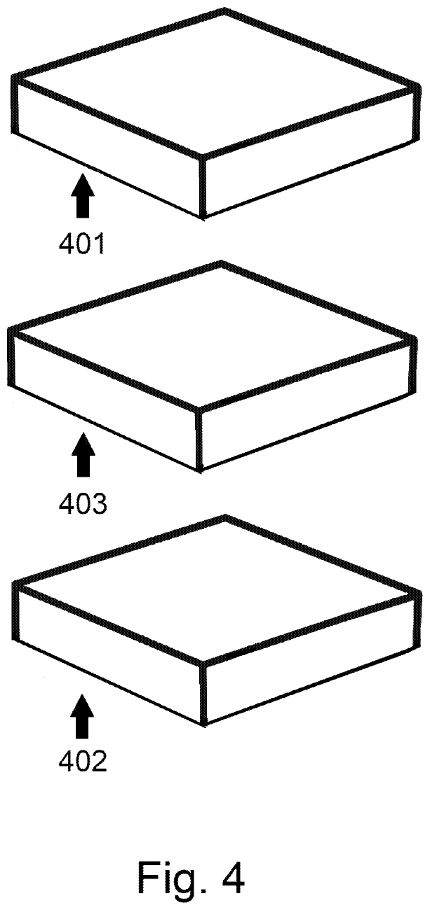

FIG. 4 shows a filler of a dog or cat bed/pillow infused with Tachyon. The outside layer or fabric of the bed (402) covers an inner layer of the bed (401). The inner layer (401) is porous so as to permit the Tachyon or Tachyon and shugite with which the filler is infused, to allow harmless energy to flow towards the dog or cat (403).

Although, there has been shown and described the preferred embodiment of the present invention, it will be readily apparent to those skilled in the art that modifications may be made thereto which do not exceed the scope of the appended claims. In some embodiments, the figures presented in this patent application are drawn to scale, including the angles, ratios of dimensions, etc. In some embodiments, the figures are representative only and the claims are not limited by the dimensions of the figures. In some embodiments, descriptions using the phrase “comprising” includes embodiments that could be described as “consisting essentially of” or “consisting of,” and as such the written description requirement for claiming one or more embodiments of the present invention using the phrase “consisting essentially of” or “consisting of” is met.

I claim:

1. An electromagnetic frequency (EMF) remediation collar for converting chaotic EMF waves into non-damaging waves, the collar comprising:
A. a Tachyon infused base strip having a first end and a second end;
B. a first fastener disposed on the first end of the base strip;
C. A second fastener disposed on the second end of the base strip.
wherein the first fastener is attachable to the second fastener, such that the base strip forms a loop when both fasteners are connected.

2. The collar of claim 1, wherein the base strip comprises a webbing material.

3. The collar of claim 1, wherein the first fastener and the second fastener comprise a hook and loop fastener.

4. The collar of claim 1, wherein the first fastener comprises a male buckle member and the second fastener comprises a female buckle member.

5. The collar of claim 1 further comprising a leash ring.

6. An electromagnetic frequency (EMF) remediation bed for converting chaotic EMF waves into non-damaging waves, the bed containing: a Tachyon infused filler material.
